(19) United States
(12) Patent Application Publication
(10) Pub. No.: US 2025/0306895 A1
(43) Pub. Date: Oct. 2, 2025

(54) SOFTWARE UPDATE MANAGEMENT DEVICE AND SOFTWARE UPDATE MANAGEMENT METHOD

(71) Applicant: HONDA MOTOR CO., LTD., Tokyo (JP)

(72) Inventors: Takashi Tsujioka, Tokyo (JP); Takayoshi Nakamura, Tokyo (JP)

(21) Appl. No.: 19/016,384

(22) Filed: Jan. 10, 2025

(30) Foreign Application Priority Data
Mar. 26, 2024 (JP) 2024-048944

(51) Int. Cl. G06F 8/65

(52) U.S. Cl. CPC G06F 8/65

(57) ABSTRACT

A software update management device that includes: a notification unit configured to notify update information regarding update of software of a vehicle control unit, the vehicle control unit being mounted on a vehicle and configured to control monitoring equipment that monitors the vehicle. The notification unit notifies, along with the update information, alternative device information regarding an alternative device that is capable of monitoring the vehicle when updating the software of the vehicle control unit, the alternative device being different from the monitoring equipment.

### INCORPORATION BY REFERENCE

The present application claims priority under 35 U.S.C. § 119 to Japanese Patent Application No. 2024-048944 filed on Mar. 26, 2024. The content of the application is incorporated herein by reference in its entirety.

### BACKGROUND OF THE INVENTION

### Field of the Invention

The present invention relates to a software update management device and a software update management method.

### Description of the Related Art

In recent years, researches and developments on traffic safety, which are beneficial for efficient energy use, have been conducted for allowing more people to have access to reasonable, reliable, sustainable, and advanced energy. For example, Japanese Patent Laid-Open No. 2006-082648 discloses a technique for enabling rewriting of programs while ensuring security of vehicles. When the system disclosed in Japanese Patent Laid-Open No. 2006-082648 attempts to rewrite a program on a security-related ECU that controls the security functions of the vehicle and if the user is not nearby the vehicle, the system brings the program rewriting to a halt.

The technique disclosed in Japanese Patent Laid-Open No. 2006-082648 does not allow program rewriting unless the user is nearby the vehicle. The problem with this is that it is difficult to secure the opportunities to update the software.

In order to overcome the problem, it is an object of the present application to enable update of the software related to vehicle monitoring while ensuring security of the vehicle, and improve the safety. This consequently improves the traffic safety still further and contributes to development of sustainable transportation systems.

### SUMMARY OF THE INVENTION

One aspect of the present disclosure is a software update management device that includes: a notification unit configured to notify update information regarding update of software of a vehicle control unit, the vehicle control unit being mounted on a vehicle and configured to control monitoring equipment that monitors the vehicle, in which the notification unit notifies, along with the update information, alternative device information regarding an alternative device that is capable of monitoring the vehicle when updating the software of the vehicle control unit, the alternative device being different from the monitoring equipment.

Another aspect of the present disclosure is a software update management device that includes: an update control unit configured to update software of a vehicle control unit that is mounted on a vehicle and configured to control monitoring equipment that monitors the vehicle; and a substitution processing unit configured to perform processing for operating an alternative device, when the update control unit is to update the software of the vehicle control unit and importance of the update of the software of the vehicle control unit is high, and when the alternative device that is capable of monitoring the vehicle and is different from the monitoring equipment is available.

Still another aspect of the present disclosure is a software update management method executed by a computer, the software update management method including: notifying update information regarding update of software of a vehicle control unit, the vehicle control unit being mounted on a vehicle and configured to control monitoring equipment that monitors the vehicle, and alternative device information regarding an alternative device that is capable of monitoring the vehicle when updating the software of the vehicle control unit, the alternative device being different from the monitoring equipment.

Yet another aspect of the present disclosure is a software update management method executed by a computer, the software update management method including: updating software of a vehicle control unit that is mounted on a vehicle and configured to control monitoring equipment that monitors the vehicle; and performing processing for operating an alternative device, when updating the software of the vehicle control unit and importance of the update of the software of the vehicle control unit is high, and when the alternative device that is capable of monitoring the vehicle and is different from the monitoring equipment is available.

According to one aspect of the present disclosure, it is possible to update the software related to monitoring of the vehicle while ensuring the security of the vehicle, by notifying the information regarding the alternative device capable of monitoring the vehicle when notifying update of the software related to monitoring of the vehicle. This makes it possible to improve the safety still further.

### BRIEF DESCRIPTION OF THE DRAWINGS

FIG. 1 is a diagram showing a configuration example of a software update system;

FIG. 2 is a diagram showing a configuration of a vehicle;

FIG. 3 is a flowchart showing an operation example of a management ECU; and

FIG. 4 is a flowchart showing an operation example of the management ECU.

### DETAILED DESCRIPTION OF THE INVENTION

Hereinafter, embodiments of the present invention will be described with reference to the accompanying drawings.

### 1. Configuration of Software Update System

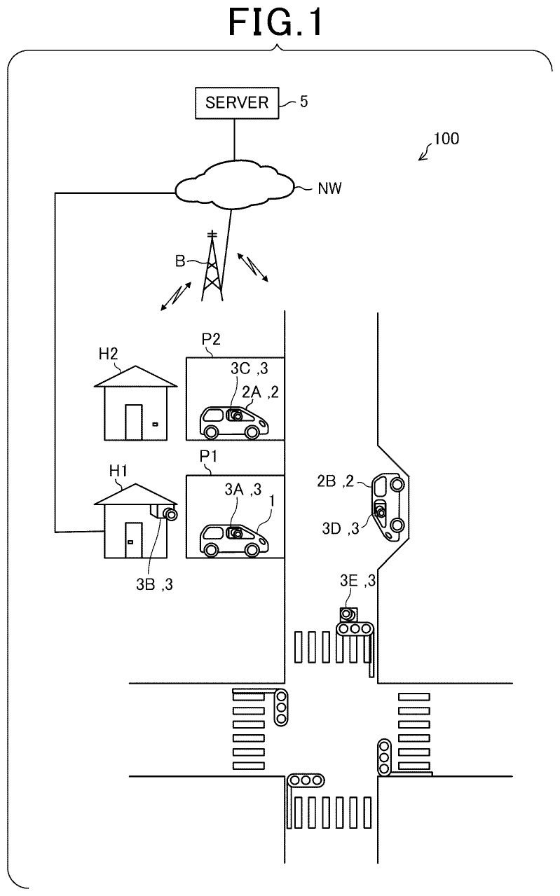

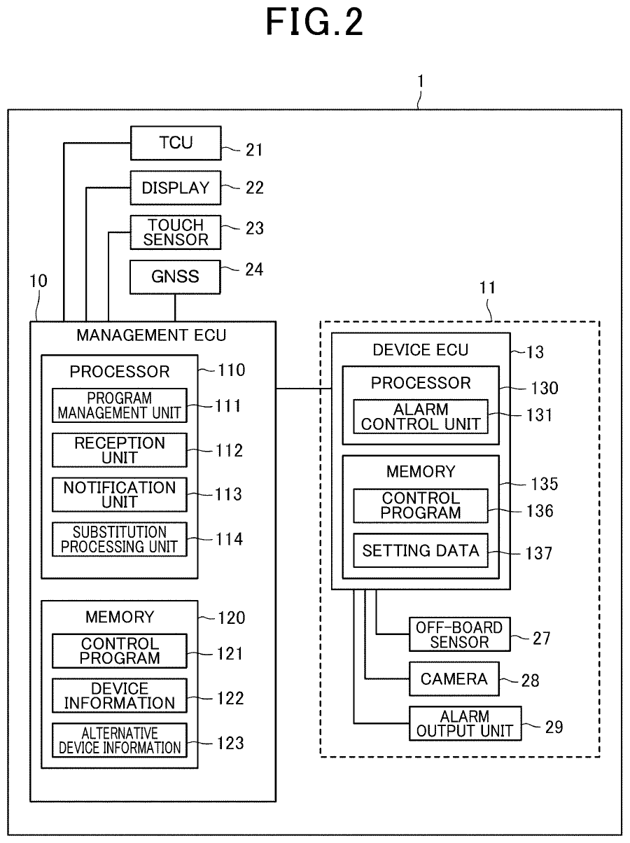

FIG. 1 is a diagram showing a configuration example of a software update system 100 related to update of software of an own vehicle 1. The software update system 100 includes a server 5 that provides software to be executed by a device ECU 13 (FIG. 2) mounted on the own vehicle 1, and the server 5 is connected to the own vehicle 1 to be communicable via a communication network NW. The own vehicle 1 downloads software from the server 5, and updates the software included in the device ECU 13. In other words, the software update system 100 enables update of the software in the own vehicle 1 by OTA (On The Air).

Note here that update of software means processing for replacing the software executed by the processor with the latest version of software, and specific forms thereof may be any of adding, deleting, and overwriting software. Furthermore, processing for deleting part of or entire software executed by the processor, installing new software, and deleting, adding, and overwriting the data used when executing the software may also be included in update of software. In the following description, software includes a program executed by a processor as well as data that is referred to, generated, updated, and deleted in association with the program, and includes firmware.

The server 5 is connected to the communication network NW via a wired communication line or a wireless communication line. The own vehicle 1 is connected to the communication network NW by wireless communication via a cellular communication base station B, for example. There is no limit set for the specific form of the communication network NW. For example, the communication network NW may include a cellular communication network, the Internet, WAN (Wide Area Network), LAN (Local Area Network), a public network, a provider device, a dedicated line, a base station, and the like.

The own vehicle 1 may be a four-wheel vehicle, a two-wheel vehicle, and any other vehicle, and may also be a large vehicle, a commercial vehicle, a work vehicle, or the like. As an example, it is assumed to be a four-wheel vehicle in the present embodiment. Furthermore, the own vehicle 1 may be any of an electric vehicle that includes a motor running on electric power as the driving source and a vehicle having an internal combustion engine mounted thereon. The internal combustion engine may function as a power source for driving the own vehicle 1, and may also be a power generation device that drives a generator. Other vehicles 2 to be described in the followings are vehicles different from the own vehicle 1. The other vehicles 2 are vehicles that have the configuration common to the own vehicle 1 or vehicles that have different configuration from the own vehicle 1, and there is no limit set for the specific form thereof.

The own vehicle 1 has a monitoring device 11 mounted thereon for the purpose of preventing vandalism to the own vehicle 1 and theft of the own vehicle 1 when the own vehicle 1 is being stopped or parked. The monitoring device monitors the own vehicle 1 by using a camera 28 (FIG. 2) and the like that capture images of the surroundings of the own vehicle 1.

While updating software related to functions of the monitoring device 11, the device ECU 13 (FIG. 2) that controls the monitoring device 11 stops the functions. Thus, the own vehicle 1 cannot be monitored. When updating the software related to the monitoring device 11 of the own vehicle 1, the software update system 100 utilizes alternative devices 3 that are capable of monitoring the own vehicle 1 instead of the monitoring device 11.

The alternative devices 3 are devices that are capable of monitoring the own vehicle 1 or the surroundings of the own vehicle 1. Examples of the alternative devices 3 are monitoring cameras installed at houses and buildings, dashboard cameras or security cameras mounted on other vehicles 2, and cameras installed at traffic lights and street lights. FIG. 1 shows a security camera 3B, cameras 3C, 3D, and a public security camera 3E as examples of the alternative devices 3. The security camera 3B is a cameral that is installed at a house H1 and captures images in a range including a parking lot P1 that is the parking space of the own vehicle 1. The camera 3C is a camera mounted on another vehicle 2A that is parked in a parking lot P2 neighboring to the parking lot P1, and it is a monitoring device or a dashboard camera of the other vehicle 2A. The camera 3D is a camera mounted on another vehicle 2B that is parked or stopped near the parking lot P1, and it is a dashboard camera, for example. The public security camera 3E is a camera installed at a traffic light near the parking lot P1 for public purpose.

Furthermore, among the cameras mounted on the own vehicle 1, the camera that operates without being controlled by the monitoring device 11 can be used as the alternative device 3. As an example, a dashboard camera 3A mounted on the own vehicle 1 will be discussed. The dashboard camera 3A is a device retrofitted to the own vehicle 1, for example, and operates without being controlled by a management ECU 10 or the device ECU 13 of the own vehicle 1 to be described in the followings.

The alternative devices 3 used in the software update system 100 can communicate with the server 5 by a communication function via the communication network NW. For example, the dashboard camera 3A can be connected to the communication network NW via the base station B or another communication device by the function of a wireless communication module mounted on the dashboard camera 3A. The security camera 3B can be connected to the communication network NW via a communication line installed in the house H1. The camera 3C can be connected to the communication network NW via the base station B or another communication device by the function of a wireless communication device mounted on the vehicle 2A or the function of a wireless communication module mounted on the dashboard camera 3C. The camera 3D is also the same. The public security camera 3E can be connected to the communication network NW via communication lines of public institutions (not shown). Note here that the wireless communication functions of the other vehicles 2A and 2B are the functions that perform communication complying with the standards of the cellular communication, Wi-Fi (registered trademark), or other mobile communication.

The server 5 executes communication with the alternative devices 3 via the communication network NW, and acquires information including positions of each of the alternative devices 3, image-capturing range, and time zone where the alternative devices 3 are available.

The security cameras 3B, 3C, 3D, and the public security camera 3E are, for example, devices owned or used by persons different from the user of the own vehicle 1. Thus, when the alternative device 3 is used in the software update system 100, the consideration for the use of the alternative device 3 may be required. Specifically, for the use of the alternative device 3 for updating software of the own vehicle 1, payment of the consideration for each of the alternative devices 3 determined in advance is required. In this case, the server 5 acquires and stores the information regarding the consideration paid to the owner or the user of the alternative device 3. Then, the payment may be made through a settlement system, not shown, based on the information stored in the server 5.

### 2. Configuration of Vehicle

FIG. 2 is a diagram showing a configuration of the own vehicle 1.

The own vehicle 1 includes a plurality of devices that implement the functions of the own vehicle 1, and includes vehicle control units that control those devices. As the devices provided in the own vehicle 1, there are an internal combustion engine functioning as a driving source of the own vehicle 1, a device for locking and unlocking the door locks of the own vehicle 1, and the like. Furthermore, the own vehicle 1 may include ICB (Infotainment Control Box), MPU (Map Positioning Unit), MVC (Multi View Camera), PKS (Parking Support System), and ADAS (Advanced Driver Assistance System). The own vehicle 1 may also include a travel motor for allowing the own vehicle 1 to travel, operation devices such as an accelerator pedal and a brake pedal as well as a VSA (Vehicle Stability Assist) device, a drive battery for driving the motor, and the like.

In the present embodiment, the operation state of the own vehicle 1 makes transition among three kinds of states including an ignition-on state, an ignition-off state, and a stopped state. The ignition-on state is a state where a motor and an internal congestion engine as the driving source of the own vehicle 1 is running. The state where the motor is running is not limited to a state where the motor is rotating. It also includes a state where the electric power can be supplied to the motor from an inverter circuit or the like, which includes a state where the motor can be promptly rotated in response to an operation of the driver such as an operation of the accelerator pedal, and the like. For example, the ignition-on state can also be expressed as a state where the inverter circuit is working. In the ignition-on state, a state where the motor is not rotating may also be referred to as an ignition-ready (IG_Ready). This state is also included in the ignition-on. When the own vehicle 1 has the internal combustion engine mounted thereon, the ignition-on state includes a state where the internal combustion engine is rotating and a state where the internal combustion engine can be promptly started. The ignition-off state is a state where the motor and the internal congestion engine as the driving source of the own vehicle 1 are inoperable, electric power is supplied at least to some of the control devices of the own vehicle 1 including the device ECU 13, and those control devices are operable. The stopped state is a state where electric power is supplied to the minimum control devices required for placing the own vehicle 1 to the ignition-off state, and supply of electric power is stopped for the other control devices and the driving source of the own vehicle 1. The monitoring device 11 operates at least in the stopped state, and may also operate in the ignition-off state.

FIG. 2 shows the monitoring device 11 as an example of the devices provided in the own vehicle 1. The monitoring device 11 includes the device ECU 13 that functions as the vehicle control unit. The device ECU (Electronic Control Unit) 13 controls the monitoring device 11 by executing a program. The monitoring device 11 is an example of a monitoring equipment.

The device ECU 13 includes a processor 130 and a memory 135. The memory 135 is a nonvolatile storage device constituted of a magnetic recording medium or a semiconductor memory element, and stores a control program 136 that is executed by the processor 130 and data that is referred to, generated, or processed when the control program 136 is executed. For example, the memory 135 stores setting data 137.

The processor 130 functions as an alarm control unit 131 by executing the control program 136. The alarm control unit 131 starts a detection operation using at least one of an off-board sensor 27 and a camera 28, having the fact that the own vehicle 1 is shifted to the stopped state as the trigger. The off-board sensor 27 may be a sensor that detects a person or an object approaching the surroundings of the own vehicle 1 outside the own vehicle 1. The off-board sensor 27 may also be a sensor that detects contact to the own vehicle 1. The off-board sensor 27 is, for example, an ultrasonic sensor, a vibration sensor, a radar sensor, or the like. During the execution of the detection operation, the alarm control unit 131 analyzes the detection result of the off-board sensor 27 and captured images captured by the camera 28. The alarm control unit 131 collates the analysis result with the setting data 137 to detect suspicious behaviors toward the own vehicle 1, vibration of the own vehicle 1, and the like. When a suspicious behavior toward the own vehicle 1 or vibration of the own vehicle 1 is detected, the alarm control unit 131 issues a notification by an alarm output unit 29 and saves the captured images of the camera 28 in the memory 135. The alarm output unit 29 is a display that displays a notification, a LED indicator that illuminates at the time of notification, other indicator lamps, a speaker that outputs a notification sound, and the like.

The own vehicle 1 includes the management ECU 10. The management ECU 10 manages update of the software of the vehicle control unit provided in the own vehicle 1. In the example illustrated in FIG. 2, the management ECU 10 has the device ECU 13 as the target, and manages update of the program executed by the device ECU 13 and the data that is processed during execution of the program. The management ECU 10 is an example of a software update management device.

A TCU (Telematics Control Unit) 21, a display 22, a touch sensor 23, and a GNSS (Global Navigation Satellite System) 24 are connected to the management ECU 10. The TCU 21 is a communication device that complies with the communication standard of a mobile communication system, and communicates with devices other than the own vehicle 1. The TCU 21 includes an antenna, a transmitter, and a receiver, for example, and performs communication under the control of the management ECU 10.

The display 22 includes a liquid crystal display panel or an organic EL (Electro Luminescence) panel, and displays characters and images. The display 22 is installed on a dashboard of the own vehicle 1, for example. The touch sensor 23 is placed by being superimposed on a display screen of the display 22, and detects touch operations of the passengers riding in the own vehicle 1. The GNSS 24 measures the location of the own vehicle 1 by receiving wireless signals transmitted from a satellite.

The management ECU 10 includes a processor 110 and a memory 120. The memory 120 is a nonvolatile storage device constituted of a magnetic recording medium or a semiconductor memory element, and stores a control program 121 that is executed by the processor 110. Furthermore, the memory 120 stores device information 122 and alternative device information 123. The device information 122 includes information regarding the devices provided in the own vehicle 1 and the vehicle control units that control those devices. The device information 122 includes, for each of the vehicle control units, for example, version, last updated data, size, and the like of the programs and data related to the operations of the respective vehicle control unit.

The alternative device information 123 is the information regarding the alternative devices 3 used when updating the software in the management ECU 10. The alternative device information 123 includes information regarding at least one of consideration for the use of the alternative devices 3, available time or time zone of the alternative devices 3, and the functions of the alternative devices 3. Furthermore, the alternative device information 123 may include information regarding the names of the alternative devices 3, locations of the alternative devices 3, owners of the alternative devices 3, and the like. The memory 120 corresponds to an example of a storage unit.

The processor 110 functions as a program management unit 111, a reception unit 112, a notification unit 113, and a substitution processing unit 114 by executing the control program 121.

The program management unit 111 manages update of the program executed by the device ECU 13 and data that is processed by the device ECU 13. The program management unit 111 makes an inquiry to the server 5 whether it is necessary to update the software of the device ECU 13 based on the device information 122. When newer version of the control program 136 and/or the setting data 137 than the control program 136 and the setting data 137 installed in the device ECU 13 can be supplied by the server 5, the program management unit 111 determines that it is necessary to update the software of the device ECU 13. In this case, the program management unit 111 downloads the update data for updating the control program 136 and/or the setting data 137 from the server 5. The program management unit 111 updates the control program 136 and/or the setting data 137 by using the downloaded update data.

The reception unit 112 detects operations on the touch sensor 23, and receives input made by the operations. The notification unit 113 gives a notification to the user of the own vehicle 1.

The notification unit 113 provides the information to the user riding in the own vehicle 1 by displaying characters and images on the display 22, for example. When it is necessary to update the software of the device ECU 13, for example, the notification unit 113 provides update information related to update of the software of the device ECU 13. The update information includes information regarding the vehicle control unit to be the target of software update, information indicating that the own vehicle 1 is in the stopped state or the ignition-off state during update, and the like.

When it is possible to use the alternative device 3 when updating the software of the device ECU 13, the notification unit 113 notifies the information included in the alternative device information 123 along with the update information of the device ECU 13. The notification unit 113 may also give a notification for requesting input regarding availability of the alternative devices 3 and, for the notification, buttons for input may be displayed on the display 22. The notification for requesting input regarding availability of the alternative devices 3 may be displayed simultaneously with the notification of the update information and the alternative device information 123, or may be displayed thereafter. The notification unit 113 performs processing in accordance with the result of the input regarding availability of the alternative devices 3.

The substitution processing unit 114 performs processing regarding the available alternative device 3 when updating the software of the device ECU 13. For example, when there is the available alternative device 3, the substitution processing unit 114 acquires the information regarding the alternative device 3 from the server 5, generates the alternative device information 123, and stores it in the memory 120. When using the alternative device 3, the substitution processing unit 114 requests the server 5 to operate the alternative device 3. The server 5 causes the alternative device 3 designated by the substitution processing unit 114 to execute an operation for monitoring the own vehicle 1 in response to the request transmitted from the substitution processing unit 114. When the alternative device 3 to be used by the substitution processing unit 114 is the dashboard camera 3A mounted on the own vehicle 1, the substitution processing unit 114 may operate the dashboard camera 3A without using the server 5.

### 3. Operations of Management ECU

### 3-1. First Operation Example

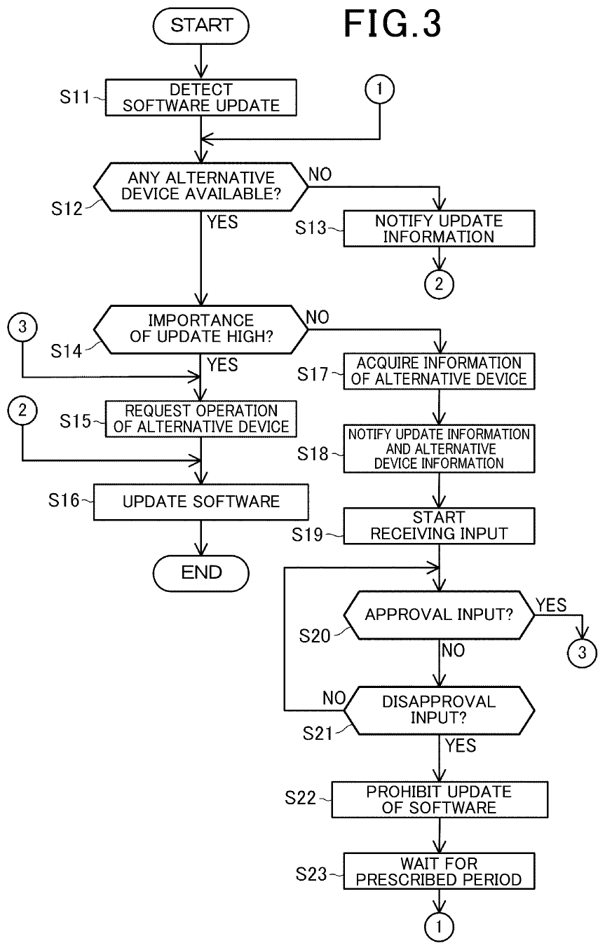

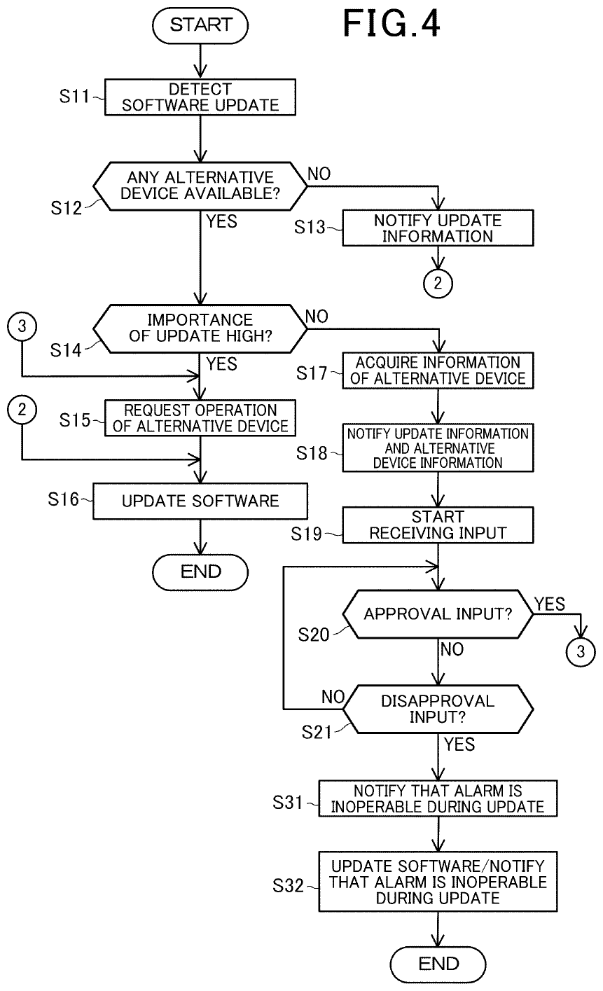

FIG. 3 and FIG. 4 are flowcharts showing operation examples of the management ECU 10. FIG. 3 shows a first operation example of the management ECU 10, and FIG. 4 shows a second operation example of the management ECU 10. The operations indicated in FIG. 3 and FIG. 4 are examples of the software update management method according to the present disclosure.

First, the first operation example of the management ECU 10 will be described with reference to FIG. 3. Steps S11 and S16 indicated in FIG. 3 are executed by the program management unit 111, step S19 is executed by the reception unit 112, steps S12, S13, S18, and S21 to S23 are executed by the notification unit 113, and steps S14, S15, and S17 are executed by the substitution processing unit 114.

Upon detecting that it is necessary to update the software of the device ECU 13 by making an inquiry to the server 5 based on the device information 122 (step S11), the management ECU 10 starts the operation indicated in FIG. 3. The management ECU 10 makes an inquiry to the server 5 or the like to determine whether there is the available alternative device 3 when updating the software of the device ECU 13 (step S12).

When it is determined that there is no available alternative device 3 (NO in step S12), the management ECU 10 notifies the update information regarding update of the software of the device ECU 13 (step S13), and shifts to step S16 to be described in the followings.

When it is determined that there is the available alternative device 3 (YES in step S12), the management ECU 10 determines whether the importance of update is high (step S14). The importance of update is notified from the server 5 to the management ECU 10. For example, in a case of highly urgent software update or when it is necessary to update the software regarding improvement in the important functions of the device ECU 13, data with a flag indicating that it is highly important update is transmitted from the server 5 to the management ECU 10. The management ECU 10 makes determination in step S14 by referring to the data transmitted from the server 5.

When the importance of the update is high (YES in step S14), the management ECU 10 requests the server 5 to operate the available alternative device 3 (step S15), and executes update of the software of the device ECU 13 (step S16).

When it is determined that the importance of the update is not high (NO in step S14), the management ECU 10 acquires the information regarding the alternative device 3 and generates the alternative device information 123 (step S17). The management ECU 10 notifies update information and the information based on the alternative device information 123 using the display 22 or the like (step S18).

The management ECU 10 gives a notification in step S18 and starts receiving input made on the touch sensor 23 or the like (step S19). In step S19, “approval input” for approving the use of the alternative device 3 and “disapproval input” for refusing the use of the alternative device 3 are received. Furthermore, when there are a plurality of available alternative devices 3, the management ECU 10 may, in step S19, receive input for selecting one of the available alternative devices 3.

The management ECU 10 determines whether approval input is entered (step S20). When approval input is entered (YES in step S20), the management ECU 10 shifts to step S15 and requests the operation of the alternative device 3. When there are a plurality of available alternative devices 3 and input for making selection of the alternative device 3 is received along with approval input, the management ECU 10 requests the operation of the selected alternative device 3 in step S15.

When approval input is not entered (NO in step S20), the management ECU 10 determines whether disapproval input is entered (step S21). When disapproval input is not entered (NO in step S21), the management ECU 10 returns to step S20. That is, the management ECU 10 waits until approval input or disapproval input is entered.

When disapproval input is entered (YES in step S21), the management ECU 10 prohibits update of the software of the device ECU 13 performed by the program management unit 111 (step S22), sets the prescribed period on standby thereafter (step S23), and returns to step S12.

As described, in the first operation example, having the device ECU 13 mounted on the own vehicle 1 as the target, the management ECU 10 causes the notification unit 113 to notify the update information regarding the update of the software of the device ECU 13. The management ECU 10 causes the notification unit 113 to notify, along with the update information, the alternative device information 123 regarding the alternative device 3 that is a device different from the monitoring device 11 and capable of monitoring the own vehicle 1 when updating the software of the device ECU 13.

When there is no available alternative device 3 when executing update of the software of the device ECU 13, the notification unit 113 does not notify the alternative device information 123. Furthermore, when the importance of update of the software of the device ECU 13 is high and the alternative device 3 is available, the substitution processing unit 114 performs processing for operating the alternative device 3, and the program management unit 111 updates the software.

Furthermore, along with the update information, the notification unit 113 notifies the alternative device information 123 that includes information regarding at least one of consideration for the use of the alternative device 3, available time or time zone of the alternative device 3, and the functions of the alternative device 3.

Furthermore, after giving the notification by the notification unit 113, the reception unit 112 receives at least one of input indicating approval or refusal for the use of the alternative device 3 and input for making selection from a plurality of alternative devices 3.

Then, when the reception unit 112 receives approval input, it is allowed to update the software of the device ECU 13 by the program management unit 111, and the program management unit 111 updates the software.

In the meantime, when the reception unit 112 receives disapproval input, it is not allowed to update the software of the device ECU 13 by the program management unit 111.

### 3-2. Second Operation Example

The second operation example of the management ECU 10 will be described with reference to FIG. 4. Steps S11 to S21 in the second operation example are common to the first operation example shown in FIG. 3, so the explanation thereof is omitted. Step S31 indicated in FIG. 4 is executed by the notification unit 113, and step S32 is executed by the program management unit 111 and the notification unit 113.

In the second operation example, upon receiving disapproval input (YES in step S21), the management ECU 10 notifies the user that the monitoring device 11 cannot be operated during update of the software (step S31). Thereafter, the management ECU 10 executes update of the software by the program management unit 111 and continues to notify that the monitoring device 11 cannot be operated while executing update (step S32). This makes it possible to securely notify the user that the function of the monitoring device 11 is stopped, when the software of the device ECU 13 is to be updated without using the alternative device 3.

### 4. Other Embodiments

Note that the embodiment described above is only one mode of the present invention, and any modifications and applications thereof are possible without departing from the scope of the present invention.

The configuration in which the alternative devices 3 and the server 5 can be connected and the substitution processing unit 114 of the management ECU 10 acquires the information regarding the alternative devices 3 from the server 5 is described in the embodiment above. However, it is only an example. For example, it is also possible to employ a configuration in which the management ECU 10 communicates with a single or a plurality of alternative devices 3, and acquires the information regarding the available alternative device 3 as well as the information regarding the consideration for the use of the alternative device 3 from the alternative device 3.

While the configuration in which the management ECU 10 that includes the program management unit 111, the notification unit 113, and the substitution processing unit 114 is provided separately from the device ECU 13 that controls the monitoring device 11 is described in the embodiment above, it is only an example. Specific arrangement of the functional units corresponding to the management ECU 10 can be changed as appropriate. For example, any of the vehicle control units provided in the own vehicle 1 may have the functions of the program management unit 111, the notification unit 113, and the substitution processing unit 114 of the management ECU 10 and may have the function of the reception unit 112. Furthermore, the management ECU 10 may be a configuration that has the same functions as those of the device ECU 13.

Note that FIG. 2 is a schematic diagram which, in order to facilitate the understanding of the invention of the present application, shows the configuration of the own vehicle 1 in blocks. However, the subject to which the present disclosure is applied is not limited to the configuration illustrated therein. Furthermore, the processing of each of the structural elements may be executed by a single hardware unit or may be executed by a plurality of hardware units. Moreover, the processing shown in FIG. 3 and FIG. 4 may be executed by a single program or may be executed by a plurality of programs.

### 5. Configuration Supported by the Embodiments

The above-described embodiments support the following configurations.

(Configuration 1) A software update management device including: a notification unit configured to notify update information regarding update of software of a vehicle control unit, the vehicle control unit being mounted on a vehicle and configured to control monitoring equipment that monitors the vehicle, in which the notification unit notifies, along with the update information, alternative device information regarding an alternative device that is capable of monitoring the vehicle when updating the software of the vehicle control unit, the alternative device being different from the monitoring equipment.

According to the software update management device of configuration 1, it is possible to update the software related to monitoring of the vehicle while ensuring the security of the vehicle, by notifying the information regarding the alternative device capable of monitoring the vehicle when notifying update of the software related to monitoring of the vehicle. This makes it possible to improve the safety still further.

(Configuration 2) The software update management device according to configuration 1, including a reception unit configured to receive at least one of input indicating approval or refusal for use of the alternative device and input for making selection from a plurality of the alternative devices, after the notification unit gives a notification.

According to the software update management device of configuration 2, it is possible to perform the processing that reflects the intention of the user, after giving the notification regarding update of the software and the alternative device. This makes it possible to improve the convenience.

(Configuration 3) The software update management device according to configuration 2, in which, when the reception unit receives the input indicating approval for the use of the alternative device or the input for making selection from the plurality of alternative devices, update of the software of the vehicle control unit is allowed to be executed.

According to the software update management device of configuration 3, it is possible to update the software while ensuring the security of the vehicle by using the alternative device.

(Configuration 4) The software update management device according to configuration 2 or 3, in which, when the reception unit receives the input indicating refusal for the use of the alternative device, update of the software of the vehicle control unit is not allowed to be executed.

According to the software update management device of configuration 4, it is possible to prevent decrease in the security of the vehicle caused due to update of the software.

(Configuration 5) The software update management device according to configuration 2 or 3, in which, when the reception unit receives the input indicating refusal for the use of the alternative device, the notification unit notifies that the monitoring equipment is inoperable during update of the software of the vehicle control unit.

According to the software update management device of configuration 5, the influence imposed upon the security of the vehicle due to update of the software can be notified to the user.

(Configuration 6) The software update management device according to any one of configurations 1 to 5, in which the alternative device information notified by the notification unit includes information regarding at least one of consideration for use of the alternative device, available time or time zone of the alternative device, and a function of the alternative device.

According to the software update management device of configuration 6, the detailed information regarding the use of the alternative device can be provided to the user.

(Configuration 7) The software update management device according to configuration 2 or 3, in which, when the reception unit receives the input indicating refusal for the use of the alternative device and update of the software of the vehicle control unit is to be executed, it is notified during update of the software that the monitoring equipment is inoperable due to update of the software of the vehicle control unit.

According to the software update management device of configuration 7, it is possible to execute update of the software according to the intention of the user, and to notify the influence imposed upon the security of the vehicle due to update of the software to the user.

(Configuration 8) The software update management device according to any one of configurations 1 to 5, in which, when there is no available alternative device when executing update of the software of the vehicle control unit, the notification unit does not notify the alternative device information.

According to the software update management device of configuration 8, it is possible to omit unnecessary processing associated with update of the software, which makes it possible to improve the convenience.

(Configuration 9) A software update management device including: an update control unit configured to update software of a vehicle control unit that is mounted on a vehicle and configured to control monitoring equipment that monitors the vehicle; and a substitution processing unit configured to perform processing for operating an alternative device, when the update control unit is to update the software of the vehicle control unit and importance of the update of the software of the vehicle control unit is high, and when the alternative device that is capable of monitoring the vehicle and is different from the monitoring equipment is available.

According to the software update management device of configuration 9, when updating the software related to monitoring of the vehicle, it is possible to promptly execute highly important update while ensuring the security of the vehicle. This makes it possible to improve the safety still further.

(Configuration 10) A software update management method executed by a computer, the software update management method including: notifying update information regarding update of software of a vehicle control unit, the vehicle control unit being mounted on a vehicle and configured to control monitoring equipment that monitors the vehicle, and alternative device information regarding an alternative device that is capable of monitoring the vehicle when updating the software of the vehicle control unit, the alternative device being different from the monitoring equipment.

According to the software update management method of configuration 10, it is possible to update the software related to monitoring of the vehicle while ensuring the security of the vehicle, by notifying the information regarding the alternative device capable of monitoring the vehicle when notifying update of the software related to monitoring of the vehicle. This makes it possible to improve the safety still further.

(Configuration 11) A software update management method executed by a computer, the software update management method including: updating software of a vehicle control unit that is mounted on a vehicle and configured to control monitoring equipment that monitors the vehicle; and performing processing for operating an alternative device, when updating the software of the vehicle control unit and importance of the update of the software of the vehicle control unit is high, and when the alternative device that is capable of monitoring the vehicle and is different from the monitoring equipment is available.

According to the software update management method of configuration 11, when updating the software related to monitoring of the vehicle, it is possible to promptly execute highly important update while ensuring the security of the vehicle. This makes it possible to improve the safety still further.

### REFERENCE SIGNS LIST

1 Vehicle
2, 2A Other vehicle
3 Alternative device
3A Dashboard camera
3B Security camera
3C, 3D Camera
3E Public security camera
5 Server
10 Management ECU
11 Monitoring device (monitoring equipment)
13 Device ECU (vehicle control unit)
21 TCU
22 Display
23 Touch sensor
24 GNSS
27 Off-board sensor
28 Camera
29 Alarm output unit
100 Software update system
110 Processor
111 Program management unit
112 Reception unit
113 Notification unit
114 Substitution processing unit
120 Memory
121 Control program
122 Device information
123 Alternative device information
130 Processor
131 Alarm control unit
135 Memory
136 Control program
137 Setting data
NW Communication network

1. A software update management device comprising:
a notification unit configured to notify update information regarding update of software of a vehicle control unit, the vehicle control unit being mounted on a vehicle and configured to control monitoring equipment that monitors the vehicle, wherein
the notification unit notifies, along with the update information, alternative device information regarding an alternative device that is capable of monitoring the vehicle when updating the software of the vehicle control unit, the alternative device being different from the monitoring equipment.

2. The software update management device according to claim 1, comprising a reception unit configured to receive at least one of input indicating approval or refusal for use of the alternative device and input for making selection from a plurality of the alternative devices, after the notification unit gives a notification.

3. The software update management device according to claim 2, wherein, when the reception unit receives the input indicating approval for the use of the alternative device or the input for making selection from the plurality of alternative devices, update of the software of the vehicle control unit is allowed to be executed.

4. The software update management device according to claim 2, wherein, when the reception unit receives the input indicating refusal for the use of the alternative device, update of the software of the vehicle control unit is not allowed to be executed.

5. The software update management device according to claim 2, wherein, when the reception unit receives the input indicating refusal for the use of the alternative device, the notification unit notifies that the monitoring equipment is inoperable during update of the software of the vehicle control unit.

6. The software update management device according to claim 1, wherein the alternative device information notified by the notification unit includes information regarding at least one of consideration for use of the alternative device, available time or time zone of the alternative device, and a function of the alternative device.

7. The software update management device according to claim 2, wherein, when the reception unit receives the input indicating refusal for the use of the alternative device and update of the software of the vehicle control unit is to be executed, it is notified during update of the software that the monitoring equipment is inoperable due to update of the software of the vehicle control unit.

8. The software update management device according to claim 1, wherein, when there is no available alternative device when executing update of the software of the vehicle control unit, the notification unit does not notify the alternative device information.

9. A software update management device comprising:
an update control unit configured to update software of a vehicle control unit that is mounted on a vehicle and configured to control monitoring equipment that monitors the vehicle; and
a substitution processing unit configured to perform processing for operating an alternative device, when the update control unit is to update the software of the vehicle control unit and importance of update of the software of the vehicle control unit is high, and when the alternative device that is capable of monitoring the vehicle and is different from the monitoring equipment is available.

10. A software update management method executed by a computer, the software update management method comprising:
notifying update information regarding update of software of a vehicle control unit, the vehicle control unit being mounted on a vehicle and configured to control monitoring equipment that monitors the vehicle, and alternative device information regarding an alternative device that is capable of monitoring the vehicle when updating the software of the vehicle control unit, the alternative device being different from the monitoring equipment.

11. A software update management method executed by a computer, the software update management method comprising:
updating software of a vehicle control unit that is mounted on a vehicle and configured to control monitoring equipment that monitors the vehicle; and
performing processing for operating an alternative device, when updating the software of the vehicle control unit and importance of the update of the software of the vehicle control unit is high, and when the alternative device that is capable of monitoring the vehicle and is different from the monitoring equipment is available.
